(19) United States
(12) Patent Application Publication
(10) Pub. No.: US 2011/0138675 A1
(43) Pub. Date: Jun. 16, 2011

(54) Radio controlled fish finding lure float

(76) Inventor: Justin Bredar Cutts, Houston, TX (US)

(21) Appl. No.: 12/799,461

(22) Filed: Apr. 26, 2010

Related U.S. Application Data
(60) Provisional application No. 61/284,058, filed on Dec. 12, 2009.

(51) Int. Cl. A01K 97/00; A01K 97/12; A01K 91/02

(52) U.S. Cl. 43/4; 43/25; 43/17; 43/26.1

(57) ABSTRACT

The fishing lure float has long been available as an indicating device to alert fishermen of the presence of nibbling or striking fish The claims presented herein, advance the original fishing lure float beyond its former, limited role as an indicator. The Radio Controlled Fish Finding Lure Float combines recasting, trolling, and fish finding capability into one unit, while keeping the water and the environment as undisturbed as possible, all at an affordable price. More advanced releases of this technology allows for the detection of a force hitting the end of the lead line. Similarly, means for indicating the submergence of the float can be added to even more advanced models. The addition of global positioning technology to the float allows for the recording of locations and monitoring of aquatic life in specific areas. The addition of the remotely controlled lead line spool winch aids in the control of depth of the lead line. By combining the above features onto a larger, more stable platform, and with the aid of solar collectors, cameras, and a tether line spool, unmanned automated activities may be controlled from afar by computer systems for the aid in rudimentary offshore operations.

### CROSS-REFERENCE TO RELATED APPLICATIONS

This application claims the benefit of PPA 61/284,058, 2009 Dec. 12 by the present inventor.

Search Reference:
Fishing—Nothing Relevant in Prior Art
Float—Nothing Relevant in Prior Art
Lure—Nothing Relevant in Prior Art
Boat—Nothing Relevant in Prior Art
Fish Finder—Nothing Relevant in Prior Art
Humminbird® rf 25—A fishing rod mounted fish finding display offered for sale at Academy® Sports and Outdoors in Houston, Tex., in January 2010.
http://store.humminbird.com/category/296590/SmartCast_Series (2 April, 2010).
Justin Manley, “The Wave Glider—An Energy Harvesting Unmanned Surface Vehicle,” Marine Technology Reporter, November/December 2009, Volume 52, No. 9. The only relevant subject matter in this article relates to the dependent claim 11, of an alternative embodiment.

### FEDERALLY SPONSORED RESEARCH AND DEVELOPMENT

None

### SEQUENCE LISTING OR TABLES

None

### BACKGROUND OF THE INVENTION

1. Field of Invention

The intent of these claims are to advance fishing and offshore technology to aid in the access, and stealth of rich fishing waters which were previously unavailable to those without access to hip waders or boats.

2. Background of the Invention

Without the aid of a boat or waders, fishermen were limited to fishing the waters within casting distance of the shore, unaware of what lie beneath the surface of his lure, requiring the repetitious act of recasting the lure. Furthermore, previous fishing technology required the exorbitant investment of a boat in order to troll for fish.

A recent advancement in fishing technology is the rod mounted fish finder provided by Humminbird®, offered for sale at Academy® Sports and Outdoors. This unit requires the recasting of the transducer, located in place of the float on the fishing line just above the hook, in order to mobilize or relocate the transducer, needlessly splashing the water as the transducer/float impacts its surface. This lack of repositioning technology disturbs the water during recasting possibly alerting the aquatic life of dangerous predators, resulting in a decrease in catches for the angler. Remote repositioning of the transducer is currently unavailable. Thus, the repositioning of the float, and associated components, via radio control would be a great advancement over the current state of technology.

Indication of a nibble or an actual taking of the lure is not very distinguishable, and hasn't improved beyond the float geometry, under the current float technology. Furthermore, the only indication in the range of external forces on the lure is allocated by the specific geometry remaining above the water on traditional floats, or the reserve buoyancy. (For a spherically shaped float, the amount of force required to increased the draft of the float by 10 percent of the height when the undisturbed float has 60 percent of its height submerged is greater than when the undisturbed float has 80 percent of its height submerged.) This allows a knowledgeable angler to determine the force on the lure and react accordingly to a nibble or a strike. By the addition of sensors and display devices, the difference in a force on the lure versus its submergence can be determined by due to the different indicators.

Although global positioning systems are relatively inexpensive, the typical platforms, fishing vessels onto which they are mounted, are prohibitively expensive for the average fisherman. The remotely operated fish float acts as a maneuverable floating platform onto which such technologic advances can be mounted.

Traditional floats have a fixed depth of the lure below the float, making the snagging of rocks, and the entanglement on submerged debris more probable than if the fisherman had the ability to adjust the depth of the lure based upon depth readings from the transducer. Typically, this would require the reeling in of the float, its manual movement, and the recasting of the lure, disturbing the surface of the water. With a remotely controlled reel on the float, this depth can be adjusted while the float is in use statically or while trolling, increasing the possibility of a strike.

Solar panels and cameras on unmanned roving offshore platforms, for the use in assessing the condition of unmanned offshore installations have been depicted in an article featured in Marine Technology Reporter. However, this article does not address automated activities related to the processing of aquatic life or the servicing of offshore installations. With the addition of automation and advanced software to the system, the platform can be used unattended by man for the aid in offshore installations.

### OBJECTS AND ADVANTAGES

Accordingly, besides the objects and advantages of the Radio Controlled Fish Finding Lure Float as described in my above patent, several objects and advantages of the present invention are:
a. to provide repositioning of the lure by means of remote control;
b. to provide control of the fishing lure provided by the control signaling device contiguous to a fishing rod, fishing station, or computer terminal;
c. to provide for the detection of fish and the underwater terrain through the use of a transducer contiguous to the float and a display contiguous to the control signaling device, station, or computer terminal;
d. to provide for detection of a small force on the hook, such as a nibble, disposed to the float, where indication would be provided on the control device, station, or computer terminal;
e. to provide for detection of a large force on the hook or submergence of float, such as a strike, disposed to the float, where indication would be provided on the control device, station, or computer terminal;
f. to provide a global positioning device in the float and the control device along with a display and memory, station, or computer terminal;
g. to provide a plurality of remotely controlled winches on the tether and the lead line, disposed to the float, and with control and indication devices disposed on the control device.
Further objects and advantages are to provide unmanned, remotely controlled or autonomous offshore platforms for the use in fishing, offshore service, and research and development aided by the implementation of computer systems.

### SUMMARY

In accordance with the present invention the Radio Controlled Fish Finding Lure Float, comprised of a hollow water-tight shell housing a battery, circuitry, motors, gears, shaft, and mounting hardware with tether mounts, antennae, rudder, shaft and propeller on the exterior of the shell, and controlled by a remote control device mounted to a fishing rod housing a battery, circuitry, control buttons and antennae, for use in moving the float and attached lure without the need for recasting.

### DRAWINGS

### Figures

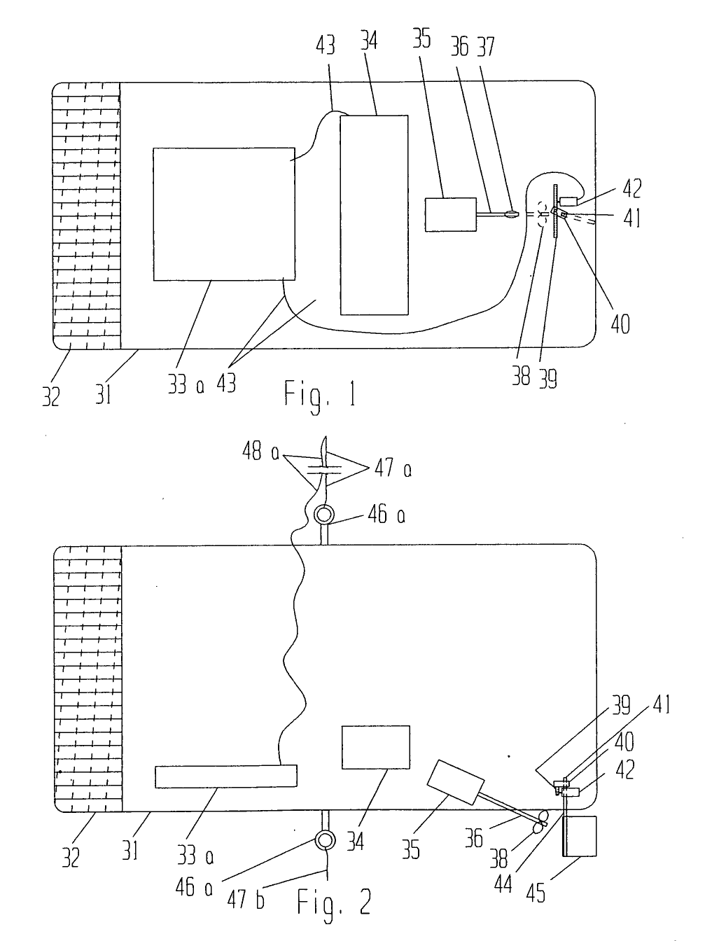

FIG. 1 shows the plan view of the float.

FIG. 2 shows the profile of the float.

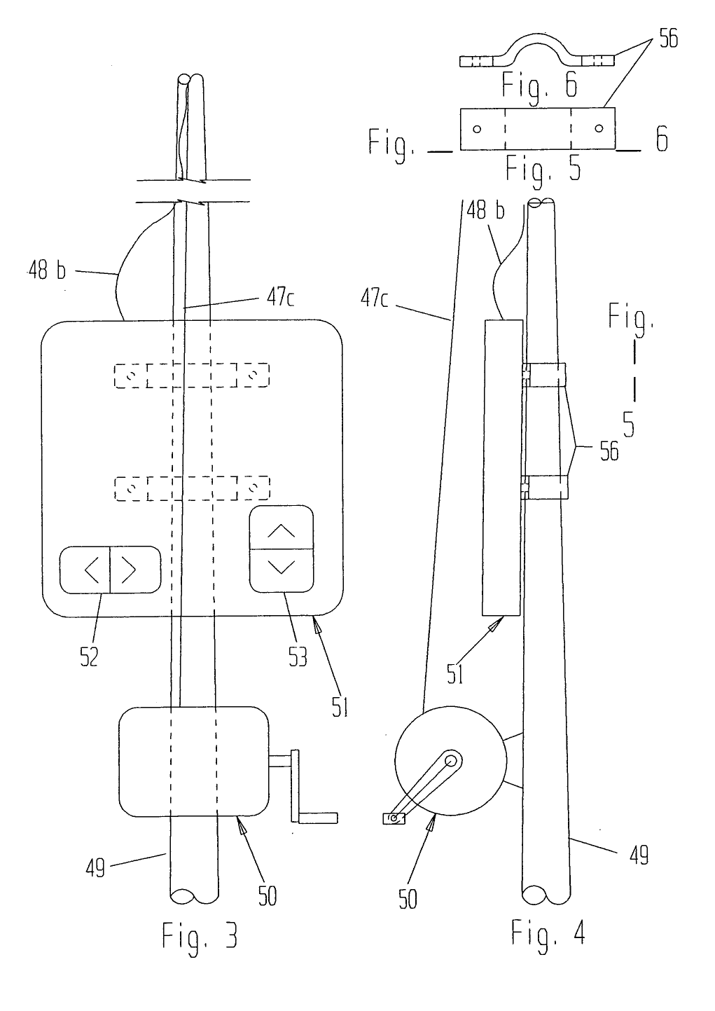

FIG. 3 shows the elevation of the device controller mounted to a fishing rod.

FIG. 4 shows the section view of the device controller mounted to a fishing rod.

FIG. 5 shows the plan of the device controller mounting hardware.

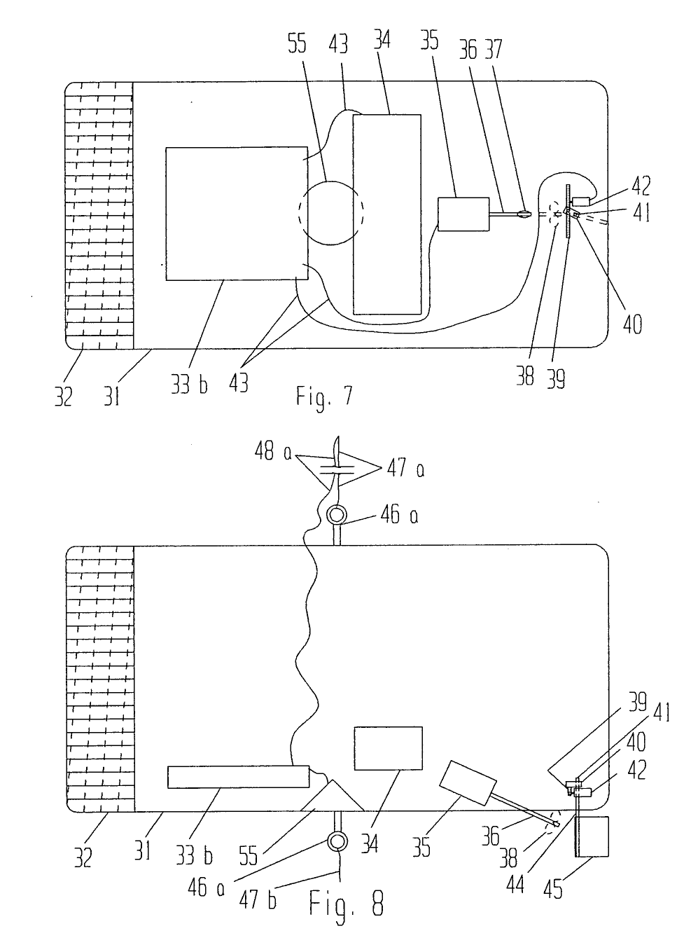

FIG. 6 shows the section view of the device controller mounting hardware.

FIG. 7 shows the plan view of the float with transducer.

FIG. 8 shows the profile float with transducer.

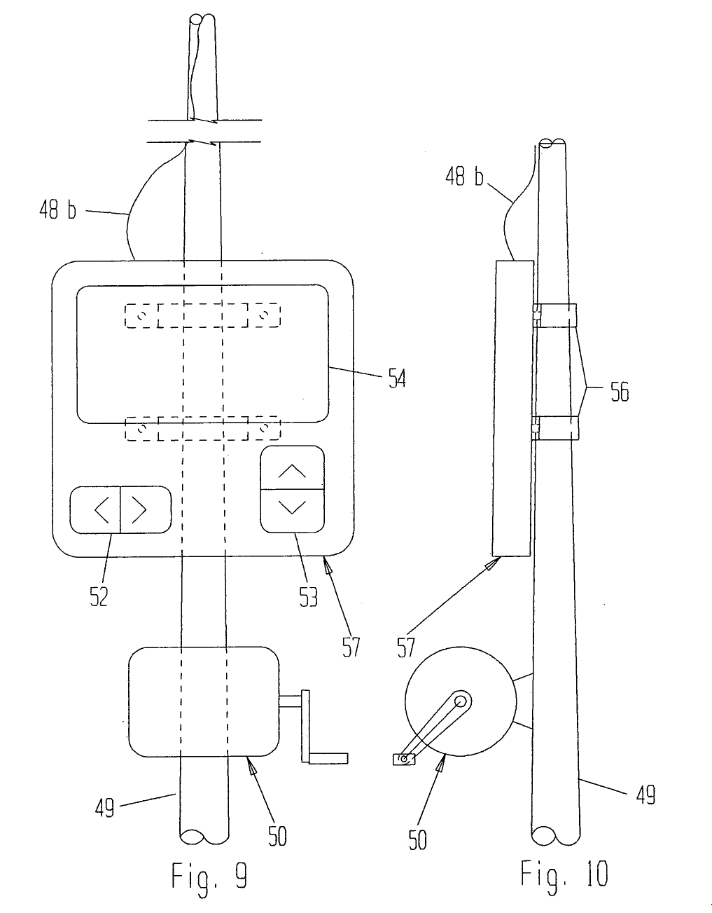

FIG. 9 shows the elevation of the device controller with display mounted to a fishing rod.

FIG. 10 shows the section view of the device controller with display mounted to a fishing rod.

FIG. 11 shows the nibble sensing device as mounted to the float.

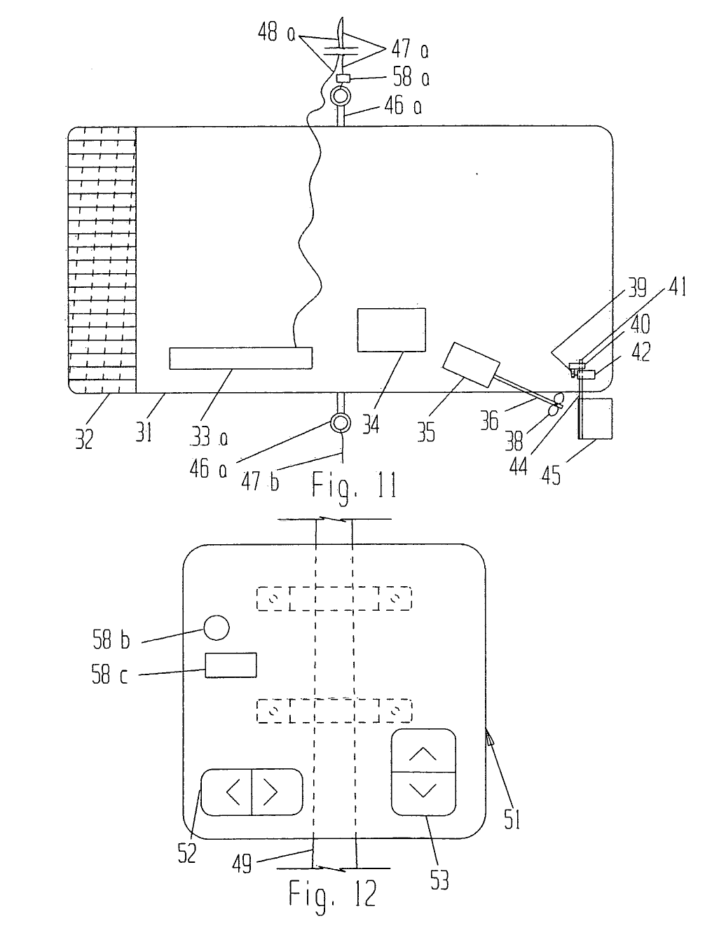

FIG. 12 shows the nibble sensing indicium device and computer system as mounted in the control unit.

FIG. 13 shows the submergence sensing device as mounted in the float.

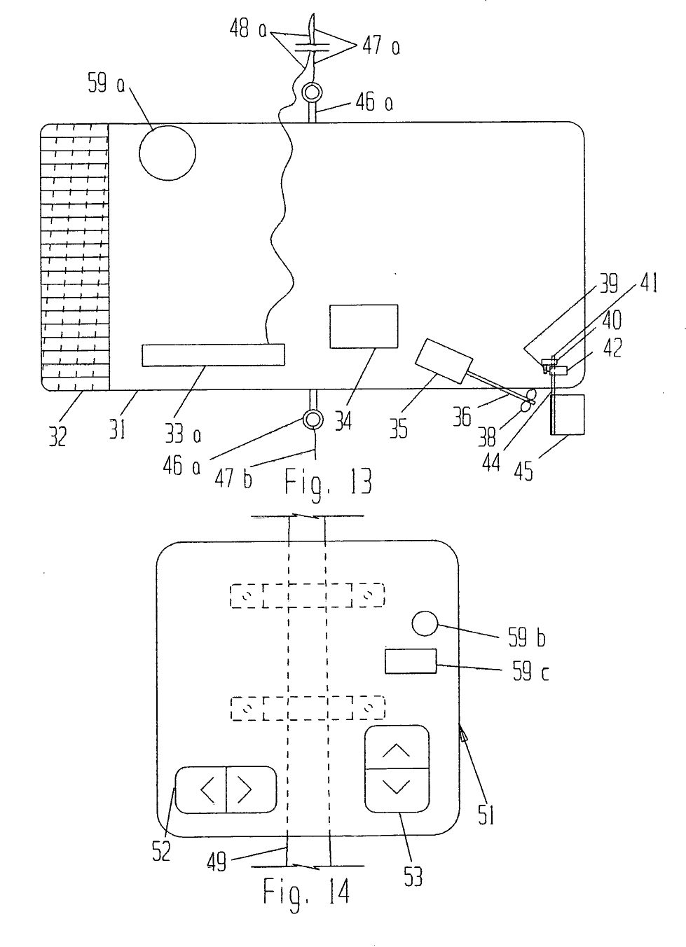

FIG. 14 shows the submergence sensing indicium device and computer system as mounted in the control unit.

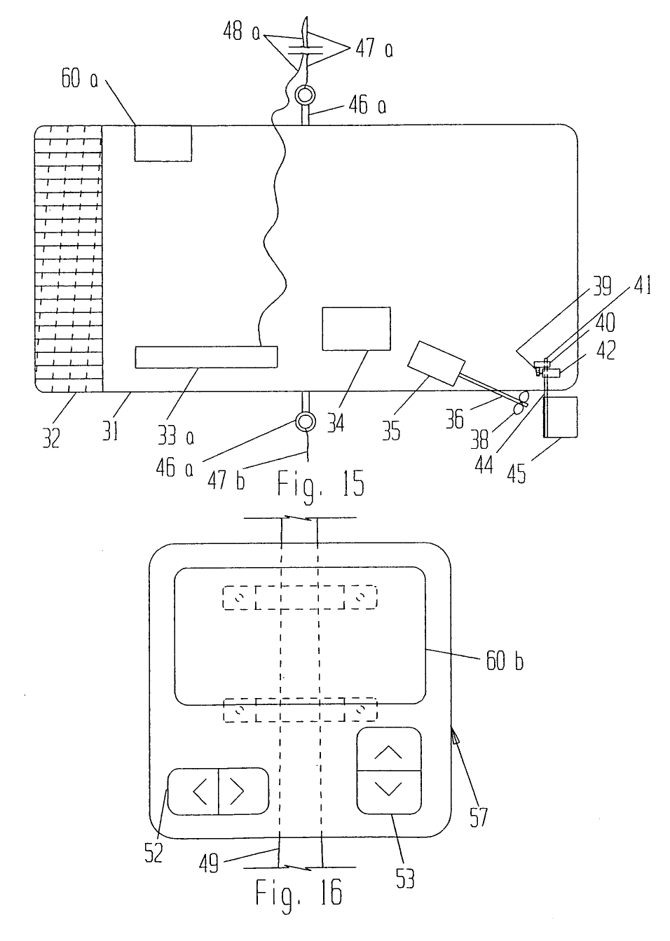

FIG. 15 shows the global positioning system as mounted in the float.

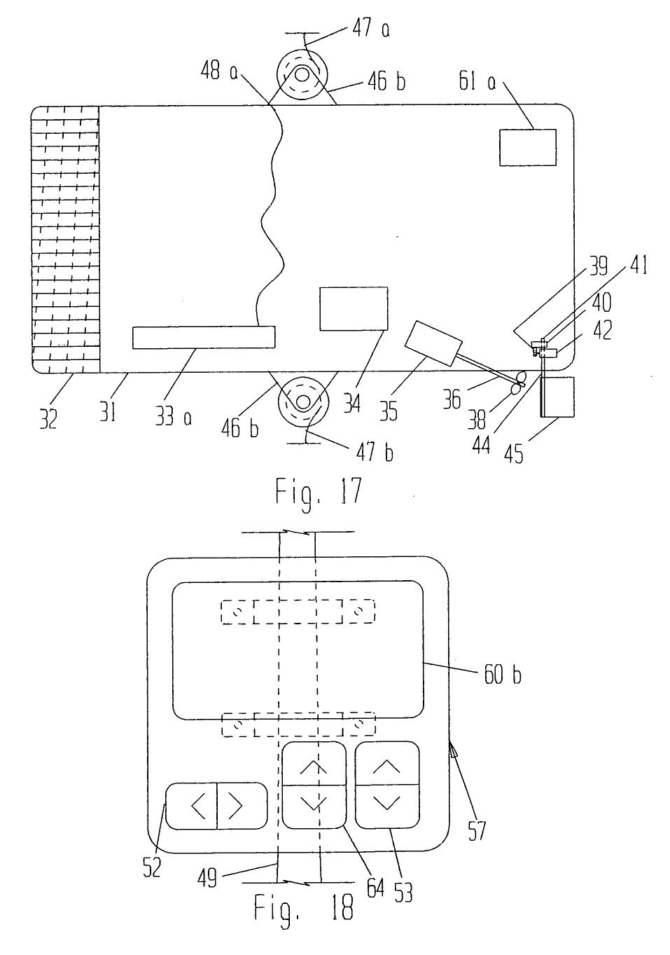

FIG. 16 shows the global positioning receiving device as mounted in the control unit.

FIG. 17 shows the tether/lead line remotely operated winch as mounted to the float.

FIG. 18 shows the tether/lead line remotely operated winch control unit as mounted in the control unit.

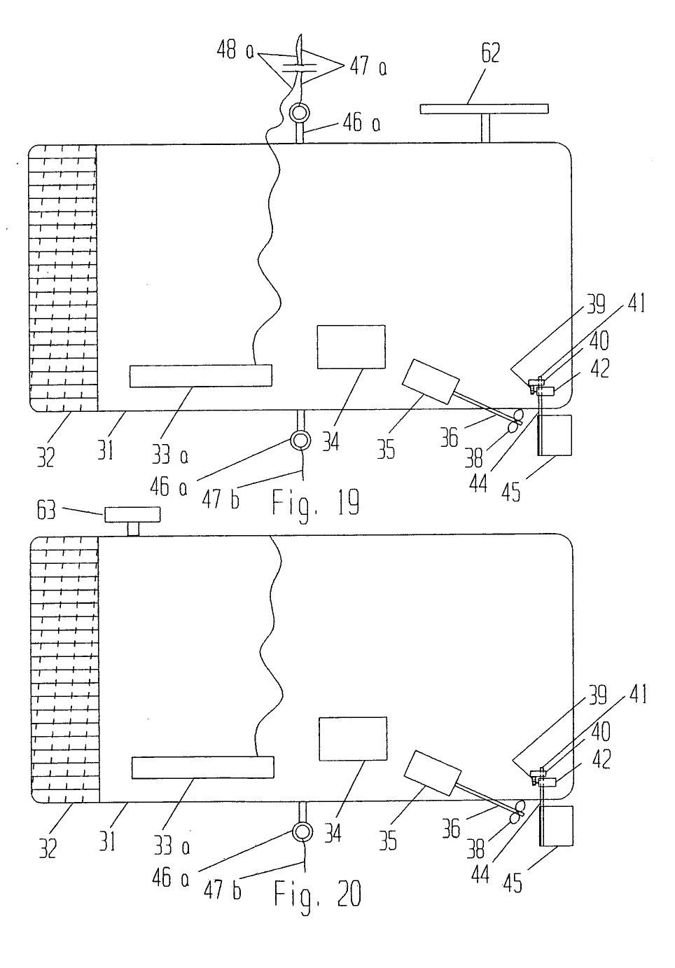

FIG. 19 shows a solar panel as mounted to the float.

FIG. 20 shows a camera as mounted to the float.

FIG. 21 shows an automated harvesting/deployment device as mounted to the float.

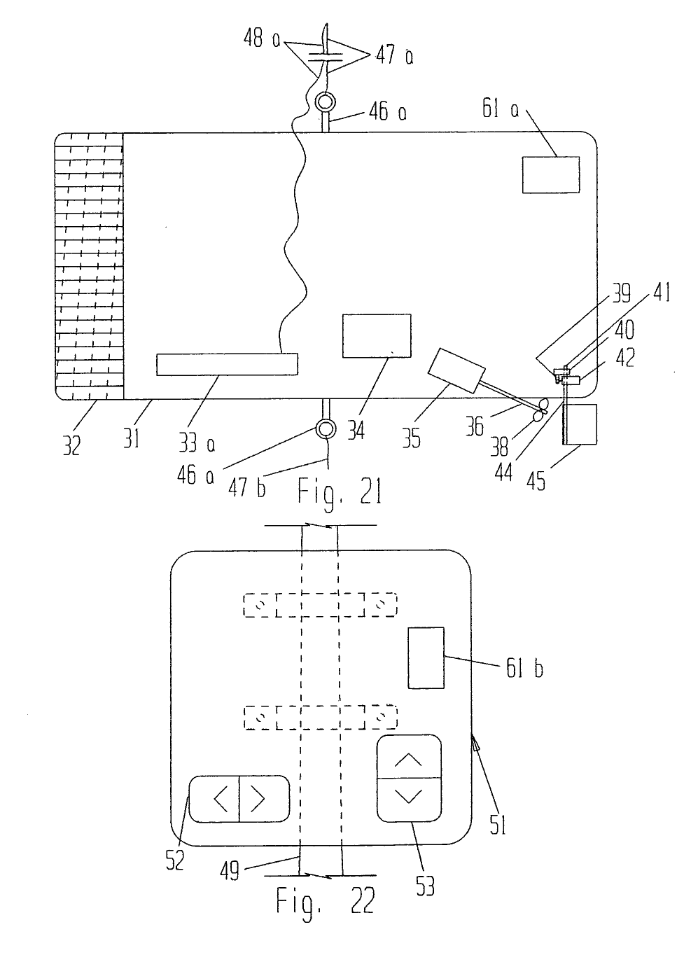

FIG. 22 shows an automated harvesting/deployment computer system as mounted in the control unit.

### REFERENCE NUMERALS

31 float or hull
32 watertight float closure device
33 circuit boards:
   a. radio controlled circuit board
   b. controller circuit board
34 battery
35 propulsion motor
36 propeller shaft
37 typical seal
38 propeller
39 rack gear
40 linkage of rack to rudder shaft
41 linkage pins
42 rudder motor
43 typical wires
44 rudder shaft
45 rudder
46 tether connection
   a. eye (static)
   b. reel (dynamic—remotely controlled reel)
47 tether
   a. line to control device tether
   b. lead line tether
   c. float tether
48 antennae
   a. float antennae
   b. control unit antennae
49 fishing rod
50 reel assembly
51 control unit assembly
52 steer left/right control
53 propel forward/reverse control
54 fish finding display
55 transducer
56 control unit mounting clips to rod
57 control/display unit assembly
58 nibble sensing device
   a. sensor and computer devices
   b. indicium device
   c. sensing computing device
59 submergence sensing device
   a. sensor and computer devices
   b. indicium device
   c. sensing computing device
60 global position system (gps)
   a. locating device
   b. computing, indicium, and processing devices
61 automated harvesting/deploying device
   a. computer system and hardware
   b. computer system to process data and/or aid in process
62 solar panel and mounting hardware
63 camera
64 reel up/down control

### DETAILED DESCRIPTION

### FIGS. 1 through 6

### Preferred Embodiment

A preferred embodiment of the present invention, the Radio Controlled Fish Finding Lure Float, is shown in FIGS. 1 (plan) and 2 (elevation). The float 31, is composed of a waterproof float or hull 31, which allows for access to the inside by a watertight float closure device 32. Inside the float 31, is a radio controlled circuit board 33a, battery 34, propulsion motor 35, propeller shaft 36, typical seal 37, rack gear 39, linkage of rack to rudder shaft 40, linkage pins 41, rudder motor 42, typical wires 43, and rudder shaft 44. In the preferred embodiment connected to the exterior of the float 31, is propeller 38, rudder 45, tether connection eye 46, line to control device tether 47a, lead line tether 47b, and float antennae 48a.

FIG. 3 (elevation) and FIG. 4 (section) show the remote control unit of the preferred embodiment. The control unit assembly 51, is built of a water-resistant casing which houses controller circuit board 33b, battery 34, steer left/right control 52, propel forward/reverse control 53, and has float tether 47c, on its exterior.

FIG. 5 (elevation) and FIG. 6 (section) show the preferred embodiment of the control mounting clips to rod 56, for rigidly connecting the control unit assembly 51, to a fishing rod 49, adjacent to the reel assembly 50.

Operation—FIGS. 1 through 6

The manner of using the Radio Controlled Fish Finding Lure Float, FIGS. 1 through 4, to position the lure and associated appurtenances is to attach the lure end of the control device tether 47a, to the tether connection eye 46a, at the top of the float 31, and attach the lead line tether 47b, to the tether connection eye 46a, at the base of the float 31. The float 31, should be positioned as a traditional float on the fishing line. Insert batteries 34, into float 31, and control unit assembly 51. Seal float 31, with watertight closure device 32. Attach control unit assembly 51, to fishing rod 49, via control unit mounting clips to rod 56, adjacent to reel assembly 50. Cast or drop into water float 31, and lead line tether 47b. To move to another spot or to troll the lure press steer left/right control 52, and propel forward/reverse control 53, as appropriate. The steer left/right control 52, and propel forward/reverse control 53, signals are sent from the control unit assembly 51, via control unit antennae 48b, to float antennae 48a, through typical wires 43, to the radio controlled circuit board 33a, where the signals are then sent to the rudder motor 42, and propulsion motor 35, respectively. From propulsion motor 35, torque is then sent through the propeller shaft 36, spinning the propeller 38, thrusting the float 31, forward. From rudder motor 42, torque is sent to the rack gear 39, which then provides a force on the linkage pins 41, and linkage of rack to rudder shaft 40, turning the rudder shaft 44, and the rudder 45; thus, steering the float 31. Typical seals 37, are present to prevent leakage.

### FIGS. 7 through 22

### Alternative Embodiments

There are various possibilities with regard to the alternate features of the Radio Controlled Fish Finding Lure Float which may be incorporated into the base design of FIGS. 1 through 6, as illustrated in FIGS. 7 through 22. FIGS. 7 and 8 show the addition of a transducer 55, and associated electronics to the float 31; FIGS. 9 and 10 show the fish finding display 54, and associated electronics added to the control/display unit assembly 57. FIG. 11 shows the nibble sensing device sensor and computing device 58a, and associated electronics mounted to the float 31; FIG. 12 shows the nibble sensing indicium device 58b, and associated electronics mounted to the control/display unit assembly 57. FIG. 13 shows the submergence sensing indicating device sensor 59a, and associated electronics mounted to the float 31; FIG. 14 shows the submergence sensing indicium device 59b, and associated electronics mounted to the control/display unit assembly 57. FIG. 15 shows the global positioning system locating device 60a, mounted to the float 31; FIG. 16 shows the global positioning system display device 60b, and associated electronics mounted to the control/display unit assembly 57. FIG. 17 shows the tether connection reel 46b, and associated electronics as mounted in the float 31; FIG. 18 shows the reel up/down control 64, and associated electronics as mounted in the control/display unit assembly 57, as required for the tether connection reel 46b. FIG. 19 shows a solar panel and mounting hardware 62, as mounted to the float 31. FIG. 20 shows a camera 63, and associated electronics for relay to the control/display unit assembly 57, as mounted to the float 31. FIG. 21 shows an automated harvesting/deploying device, computer system, and hardware 61a, as mounted to the float; FIG. 22 shows an automated harvesting/deploying device computer system to process data and/or aid in process 61b, as mounted to the control/display unit assembly 57.

Operation—FIGS. 7 through 22

To use the fish finding add-on feature of the Radio Controlled Fish Finding Lure Float, FIGS. 7, 8, 9 and 10, use the device as described above and steer the float 31, position it and the transducer 55, above aquatic life causing an indication to be displayed on the fish finding display 54, at which time the angler should cease moving the float 31. FIGS. 11 and 12 show the nibble sensing devices 58 a, b, & c, on the float 31, and control unit 51, respectively. When a small force or a nibble hits the lure attached to the float 31, the smaller force is distinguished between a larger force, such as a strike, by the nibble sensing device 58a, and a signal is sent to the nibble sensing computing device 58c, and then the nibble sensing indicium device 58b, mounted on the control unit 51. Similarly, FIGS. 13 & 14 show the submergence sensing device 59 a, b, & c. This also indicates the presence of a force on the lure except that the submergence sensing device 59a, indicates the presence of a larger force or a submergence of the float 31, and sends a signal to the submergence sensing computing device 59c, and then the submergence indicium device 59b, mounted on the control unit 51. The addition of a global positioning system 60 a, and b, shown in FIGS. 15 & 16, to the float 31, and control/display unit assembly 57, provides the angler with the ability to program favorite fishing spots or obstacles into the global positioning system computing device 60b. The global positioning locating device 60a, captures the position of the float 31, and sends a signal to the control/display unit assembly 57, displaying the location on the fish finding display 54, by means of the global positioning system processing device 60b. FIGS. 17 & 18, tether connection reel 46b, which use reel up/down control 64, mounted on the control/display unit assembly 57, to remotely lift or lower the lure attached to the float 31, via tethers 47b. FIG. 19 shows a solar panel and mounting hardware 62, for the supply of power to the float 31. FIG. 20 shows a camera 63, mounted to the outside of the float 31. FIGS. 21 and 22 show the automated harvesting/deployment device 61a and b, used in autonomous service. The automated harvesting/deployment computer system and hardware 61a, is used in the robotic, automation system; Whereas, automated harvesting/deployment computer system to process data and/or aid in process 61b, is used to maximize routines, service, or functions necessary in the use of this machine in the service of offshore installations.

### Advantages

From the description above, a number of advantages of the Radio Controlled Fish Finding Lure Float become evident;
a. The ability to reposition the lure without recasting it minimizes the disturbance of the water surface. This is a more relative when using the transducer feature due to the repositioning of the lure based upon scientific information.
b. Lures that previously would have only been used during trolling from boats may be used with this positioning technology.
c. The determination of a nibble or a strike can be determined from indicators on the control device eliminating the need to have the float within field of view.
d. Raising and lowering allows for depth to be controlled when positioning or drift fishing over uneven terrain without the need for recasting.
e. Global Positioning System (GPS) technology aids in the logging of waypoints, and reefs for use with the fish finding feature.
f. The addition of a solar panel lengthens the time the float can stay offshore.
g. The addition of a camera aids in the remote use of the float in fishing and other offshore tasks.
h. Robotics or automation added to this technology aids in the existing offshore, fishery, and research and development industries.

### CONCLUSION, RAMIFICATIONS, AND SCOPE

This technology aids the budget conscience fisherman, from the hobbyist to the largest of commercial fishing organizations, in that it provides several advanced options unavailable in the current marketplace. From the basic version's unlimited casting and trolling, to fish finding, change of lure depth by a lure winch, memory of locations through GPS, computerized enhanced positioning, automation, management, and research and development of sustainable fisheries in the most advanced generation of platforms, the Radio Controlled Fish Finding Lure Float provides the technology for advancement in any offshore activity, fisheries and offshore installations alike.

I claim:

1. A remotely controlled marine life lure, net, or trap positioning machine, comprising:
a) a hollow, watertight hull enclosure surrounding a plurality of means for a propulsion device, a guidance device, and a mechanical device necessary to position said machine
b) a plurality of means for the powering device and the remotely controlled control electronics device so as to propel and position said machine
c) means for coupling rotational energy into an aquatic propulsion device so as to propel said machine
d) means for coupling rotational energy into a steering device so as to change the angle of course of straight line motion of said machine
e) a device for sending a remotely operated control signal to said control electronics device thereby, in plurality controlling said aquatic propulsion device and said steering device of said machine,
whereby said machine can be controlled using the remotely operated control signaling device.

2. The machine of claim 1 wherein the control signaling device is contiguous to a fishing rod,
whereby the control signaling device is easily accessible by a fishing human.

3. The machine of claim 1 wherein the control signaling device is disposed adjacent to a fishing reel,
whereby the control signaling device is easily accessible by a fishing human.

4. The machine of claim 1 further including a plurality of means disposed in said machine and said control signaling device, wherein a device for providing images of submerged object is provided by a transducer and associated electrical components sends an electrical signal to a visual display or a recording device disposed in said control signaling device,
whereby the display device contiguous to said control signaling device is such that use of said control signaling device is improved by a human and a computer by the addition of said transducer disposed in said machine for the purpose of displaying submerged objects.

5. The machine of claim 1 further including a plurality of means disposed in said machine and said control signaling device, wherein means for a lure force sensing device disposed on said machine and contiguous to the lure lead line sends a signal to said control signaling device or a processor, wherein an indicium device is used by humans or a computer device is used for automated processing,
whereby, said lure force sensing device provides indication to the human or the computerized system of the presence of a nibble, false alarm, or the net or the trap which is not filled to a predetermined level.

6. The machine of claim 1 further including a plurality of means disposed in said machine and said control signaling device, wherein means for providing a signal to indicate the submergence of said machine is sent to said control signaling device, wherein an indicium device or a computerized device is disposed on said control signaling device,
whereby, said indicium device or computer device disposed on said control signaling device notifies the human or the computerized system of the submergence of said machine.

7. The machine of claim 1 further including a plurality of means disposed in said machine and said control signaling device, wherein a global positioning device records and sends a signal to said control signaling device, wherein the display device indicates, or a computerized system records the position signal for use by a human or an analysis software program,
whereby, the position signal is displayed and recorded disposed in said control signaling device for future use by a human or a computer.

8. The machine of claim 1 further including a plurality of means disposed in said machine and said control signaling device, wherein a remotely controlled spool of line disposed in said machine so that the depth of the lure or said machine may be controlled remotely by the control device with indicium or means for a computer device disposed in the control device,
whereby, the depth of the end of the end of a lead disposed on said machine or said machine may be increased or decreased by remote operation from the control device.

9. The machine of claim 1 further including a plurality of means disposed in said machine and said control signaling device, wherein a solar panel array is used in the aid of automation and unimpeded operation of said machine,
whereby, the solar panel array allows for unimpeded interruption of said machine for such use in management, research and development for offshore use.

10. The machine of claim 1 further including a plurality of means disposed in said machine and said control signaling device, wherein cameras are used in the aid of automation and unimpeded operation of said machine and the processing of data in said computer,
whereby, the solar panel array allows for unimpeded interruption of operation of said machine for such use in management, research and development for offshore use.

11. The machine of claim 1 further including a plurality of means disposed in said machine and said control signaling device, wherein a computer records and an algorithm processes the computer data so as to aid in the operation or mechanization of the use of said machine, further including a robotic deployment and retrieving device,
whereby, the computer and software processes the data of said machine, providing optimization or mechanization of the deployment and retrieving process through the use of said robotic device.
